(19) United States
(12) Patent Application Publication
(10) Pub. No.: US 2025/0237939 A1
(43) Pub. Date: Jul. 24, 2025

(54) LIGHT QUANTITY ADJUSTMENT DEVICE AND PROJECTION IMAGE DISPLAY DEVICE

(71) Applicant: Panasonic Holdings Corporation, Osaka (JP)

(72) Inventors: Shigekazu YAMAGISHI, Osaka (JP); Akihito AMANO, Osaka (JP)

(21) Appl. No.: 19/175,203

(22) Filed: Apr. 10, 2025

Related U.S. Application Data
(63) Continuation of application No. PCT/JP2023/035655, filed on Sep. 29, 2023.

(30) Foreign Application Priority Data
Oct. 14, 2022 (JP) 2022-165736

(51) Int. Cl. G03B 21/20; G03B 9/06

(52) U.S. Cl. CPC G03B 21/2053; G03B 9/06

(57) ABSTRACT

A light quantity adjustment device of the present disclosure includes: blade substrates that are each provided rotatably with a rotation axis and an actuation axis; a first member having a first center aperture, defining positions of the rotation axes along a circumferential direction; and a second member that sandwiches the blade substrates between the first member, engaging the blade substrates via the actuation axes. The blade substrates are rotatable to change an amount by which the first center aperture is shielded. Each of the blade substrates includes a first section and a second section on a tip-end side, a bottom surface of the second section is positioned higher in a thickness direction than a top surface of the first section. When viewed from the thickness direction, at least at the stopping position, the second section of each blade substrate partially overlaps the first section of adjacent blade substrates.

### CROSS REFERENCE TO RELATED APPLICATIONS

The present application is a continuation of PCT/JP2023/035655 filed on Sep. 29, 2023, which claims priority to Japanese Patent Application No. 2022-165736, filed on Oct. 14, 2022, the entire contents of each of which are incorporated herein by reference.

### TECHNICAL FIELD

The present disclosure relates to a light quantity adjustment device and a projection image display device including the light quantity adjustment device.

### BACKGROUND

A projection image display device irradiates an image display element such as a liquid crystal with strong illumination light from a light source, and enlarges a small image being displayed on the image display element using a projection lens, and projects the enlarged image.

Different contrast and brightness are required depending on the image. Therefore, there is a need for adjustment of the F-number of the projection system. When the F-number is increased, the spread of light can be suppressed and contrast can be enhanced. By contrast, when the F-number is decreased, brightness of the image can be enhanced.

As a mechanism for adjusting the F-number, there is a light quantity adjustment device that includes blades for adjusting the light quantity, and that adjusts the F-number by moving the blades and changing the aperture diameter so as to adjust the quantity of light to be passed.

As such a light quantity adjustment device, for example, the inventions according to JP 5002923 B2 and JP 2007-114405 A have been disclosed. JP 5002923 B2 discloses a light quantity adjustment device including two movable blades in an illumination optical system. JP 2007-114405 A discloses a light quantity adjustment device that moves four movable blades using a cam.

### SUMMARY

However, when the F-number is increased, a larger quantity of light hits the blades of the light quantity adjustment device, and the blades become heated by the illumination light. In such a case, burning, deformation, and breakage of the blades become a concern.

JP 5002923 B2 does not have any description in relation to the positions or heating of the blades themselves.

In relation to the heat generated as a result of shielding light, JP 2007-114405 A does not mention anything about the measures for heating and burning of the blades themselves.

Therefore, an object of the present disclosure is to solve the problem described above, and to provide a light quantity adjustment device for suppressing heating and burning of a blade.

A light quantity adjustment device according to one aspect of the present disclosure includes: a plurality of blade substrates that are each provided rotatably with a rotation axis and an actuation axis; a first member that has a first center aperture, defines positions of the rotation access along a circumferential direction of the first center aperture, and engages with base-end sides of the plurality of blade substrates via the rotation axes; and a second member that sandwiches the plurality of blade substrates between the first member, has a second center aperture communicating with the first center aperture, and engages with the plurality of blade substrates via the actuation axes, in which the plurality of blade substrates are enabled to rotate as the second member is rotated, between a housing position and a stopping position where an amount by which the first center aperture is shielded is larger than an amount by which the first center aperture is shielded at the housing position, each of the plurality of blade substrates includes a first section and a second section that is on a tip-end side with respect to the first section, a bottom surface of the second section of the blade substrate is positioned higher in a thickness direction than a top surface of the first section of the blade substrate, and, when viewed from the thickness direction, at least at the stopping position, the second section of each of the plurality of blade substrates partially overlaps with the first section of another adjacent one of the plurality of blade substrates.

A projection image display device according to one aspect of the present disclosure includes a light quantity adjustment device at or near a pupil position on a light path of illumination light.

According to the present disclosure, it is possible to provide a light quantity adjustment device that suppresses heating and burning of a blade.

### BRIEF DESCRIPTION OF DRAWINGS

FIG. 1 is a schematic configuration diagram of an example of a projection image display device according to a first embodiment;

FIG. 2A is a schematic of an example of a laser diode device;

FIG. 2B is a schematic of an example of a laser diode device;

FIG. 3 is a perspective view of a light quantity adjustment device;

FIG. 4 is an exploded view of the light quantity adjustment device;

FIG. 5A is a plan view of a blade substrate;

FIG. 5B is a side view of the blade substrate;

FIG. 5C is a schematic view illustrating two blade substrates;

FIG. 6A is a schematic of a conventional light quantity adjustment device;

FIG. 6B is a schematic of the light quantity adjustment device;

FIG. 7 is a perspective view of the light quantity adjustment device;

FIG. 8 is an example of light source images formed in a relay system;

FIG. 9A is a diagram illustrating the light quantity adjustment device at a housing position;

FIG. 9B is a view illustrating the light quantity adjustment device at the housing position;

FIG. 10A is a view illustrating the light quantity adjustment device at a stopping position;

FIG. 10B is a view illustrating the light quantity adjustment device at the stopping position;

FIG. 11 is a perspective view of a blade substrate having a support section;

FIG. 12 is a perspective view of the light quantity adjustment device;

FIG. 13 is a perspective view of a blade substrate including actuation pins;

FIG. 14A is a perspective view of a blade substrate including a roller;

FIG. 14B is a side view of the blade substrate including the roller;

FIG. 15 is a diagram illustrating another example in which an actuation pin is provided with a roller;

FIG. 16A is a plan view of a blade substrate including two sections and a support section;

FIG. 16B is a side view of the blade substrate including two sections and a support section;

FIG. 17A is a plan view of a blade substrate including a rotation pin;

FIG. 17B is a side view of the blade substrate including the rotation pin;

FIG. 18A is a diagram illustrating a light quantity adjustment device according to a second embodiment; and

FIG. 18B is a diagram illustrating the light quantity adjustment device according to the second embodiment.

### DETAILED DESCRIPTION

Light sources for projection image display devices or projecting video display devices are currently shifting from conventional discharge lamps to lasers, from the viewpoints of lifetime and environmental issues. A laser has a small spread, and a high output can be achieved by combining a large number of lasers. With a laser light source with a relatively small spread, it has become possible to efficiently guide illumination light that is closer to parallel rays than conventional counterpart, in other words, illumination light having a greater F-number, to an image display panel. As a result, stray light on the light path to the image display panel is also reduced, so that a certain level of contrast has been achieved on an image displayed in a larger size through the projection lens. However, there is a demand for even higher contrast for the purpose of image viewing.

In view of such a background, a technique for changing apparent contrast by changing the brightness of an image through the modulation of the brightness of a laser light source has come to be generally introduced. However, in this method, because the brightness of the entire image is changed simultaneously, it has not been possible to improve a window contrast, which is the ratio in brightness between a black area and white therearound, in a pattern in which a black area is presented inside a white screen, for example. Therefore, the present inventors have considered introducing a light quantity adjustment device for the purpose of improving the window contrast.

When the light quantity adjustment device is used in a projection image display device, the light quantity adjustment device receives strong illumination light because of the high output of the laser light source. Because blades of the light quantity adjustment device become heated by the illumination light, burning, deformation, or breakage of the blades becomes a concern. The present inventors however have found out that the heating of the blades can be suppressed by changing the structures of the blades.

The present inventors therefore have devised a light quantity adjustment device the reliability of which is not impaired even upon receiving strong illumination light, by improving the degree of freedom in the design of the blade structure, in a system capable of improving the window contrast, and arrived at the present disclosure.

Embodiments will now be explained in detail with reference to drawings as appropriate. However, descriptions more detailed than necessary may be omitted. For example, detailed descriptions of well-known matters and redundant descriptions of substantially the same configurations may be omitted. This is to avoid unnecessary redundancy in the following description, and to facilitate understanding of those skilled in the art.

Note that the accompanying drawings and the following description are provided to facilitate those skilled in the art to fully understand the present disclosure, and are not intended to limit the subject matter defined in the claims in any way.

### First Embodiment

### [1-1. Configuration of Projection Image Display Device]

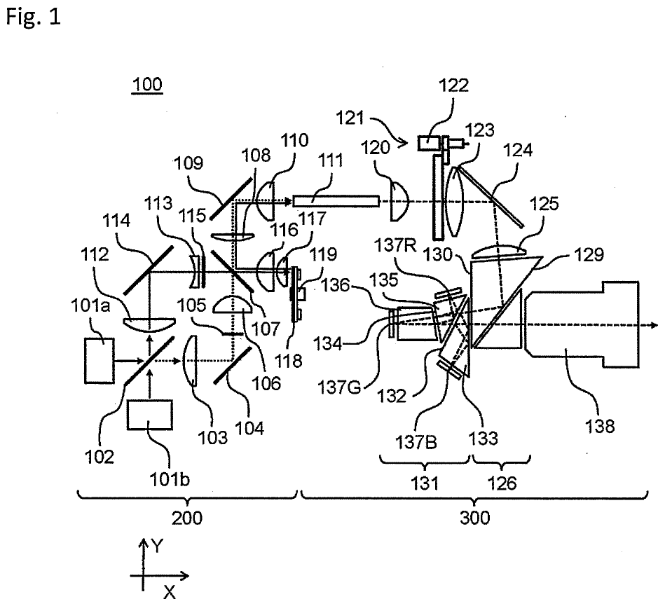

FIG. 1 is a schematic configuration diagram illustrating an example of a projection image display device 100 according to a first embodiment. As illustrated in FIG. 1, the projection image display device 100 includes a light source device 200 and an illumination optical system 300. The projection image display device 100 has a function for displaying images and videos.

The light source device 200 includes laser diode devices 101a, 101b, a partial reflection mirror 102, lenses 103, 108, 110, 112, 113, mirrors 104, 109, 114, diffusion plates 105, 115, condenser lenses 106, 116, 117, a dichroic mirror 107, a phosphor wheel 118, and a motor 119.

The illumination optical system 300 includes a rod integrator 111, relay lenses 120, 123, a mirror 124, a field lens 125, a total reflection prism 126, a color prism device 131, image forming elements (digital mirror devices (DMDs)) 137R, 137G, and 137B, and a projection lens 138.

Note that the configurations of the light source device 200 and the illumination optical system 300 illustrated herein are merely examples, and are not limited to those including the elements described above.

To begin with, the light source device 200 will be described.

In the light source device 200, the laser diode devices 101a, 101b are used as light sources. The laser diode devices 101a, 101b emit blue light having a center wavelength at 456 nm, for example.

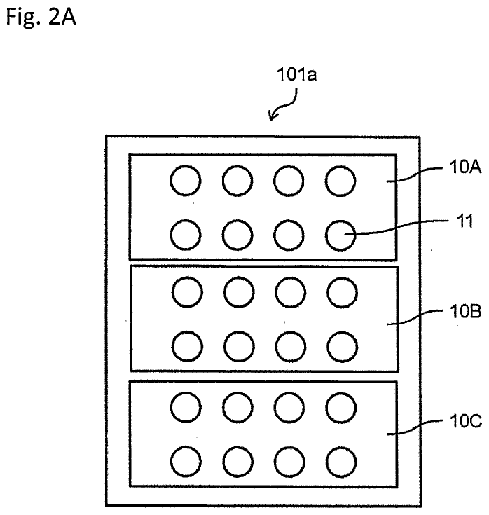

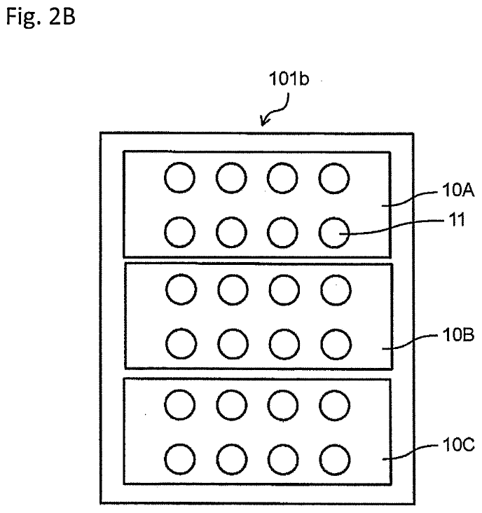

FIGS. 2A and 2B are schematics of examples of the laser diode devices 101a, 101b, respectively. As illustrated in FIGS. 2A and 2B, three laser light sources 10A, 10B, and 10C are provided. Each of the three laser light sources 10A, 10B, and 10C includes a plurality of blue laser diodes (not illustrated) and a plurality of collimator lenses 11 that are disposed on the side of the emergent surfaces of the plurality of respective blue laser diodes. The plurality of collimator lenses 11 are disposed on the optical axes of the rays of light emitted from the plurality of respective blue laser diodes.

Returning to FIG. 1, the light emitted from the laser diode devices 101a, 101b becomes incident on the partial reflection mirror 102. The partial reflection mirror 102 is a mirror having a characteristic for partially reflecting a certain amount of light at the blue wavelength.

In the partial reflection mirror 102, the blue light (dotted line) emitted in the +X direction is collected by the lens 103, reflected by the mirror 104, and then collected on the diffusion plate 105. The blue light collected on the diffusion plate 105 becomes incident on the condenser lens 106, is turned into substantially parallel rays of light, and becomes incident on the dichroic mirror 107. The dichroic mirror 107 has a characteristic transmitting blue light and reflecting the light of other colors. The blue light transmitted through the dichroic mirror 107 passes through the lens 108, the mirror 109, and the lens 110, and is collected on the incident surface of the rod integrator 111 included in the illumination optical system 300.

The blue light (solid line) output from the partial reflection mirror 102 in the +Y direction becomes converged by the lenses 112, 113 forming an afocal system with the mirror 114 interposed therebetween, and becomes incident on the diffusion plate 115. The blue light is diffused by the diffusion plate 115 and then transmits through the dichroic mirror 107. The blue light having transmitted through the dichroic mirror 107 passes through the condenser lenses 116, 117, and becomes incident on the phosphor wheel 118.

The phosphor wheel 118 includes a phosphor layer. The phosphor wheel 118 includes the motor 119, and is caused to rotate by the motor 119. The phosphor layer is formed by, for example, applying YAG phosphor that becomes excited by blue light and that is caused to emit yellow light including green and red wavelength components. The light, an image of which is substantially formed by the phosphor layer on the phosphor wheel 118, is reflected as yellow light.

The yellow light (fluorescent light) reflected by the phosphor wheel 118 passes through the condenser lenses 117, 116, and becomes incident on the dichroic mirror 107. The yellow light is reflected by the dichroic mirror 107, passes through the lens 108, the mirror 109, and the lens 110, in the same manner as the blue light, and becomes collected on the incident surface of the rod integrator 111 included in the illumination optical system 300.

In the light source device 200, when the blue light and the yellow light become collected on the incident surface of the rod integrator 111, the blue light and the yellow light (fluorescent light) become superimposed over each other and together form white light.

The illumination optical system 300 will be described next.

In the illumination optical system 300, the rod integrator 111 is formed of a transparent member such as glass. The rod integrator 111 generates light having a uniform intensity distribution by causing the incident light to reflect inside the rod integrator 111 a plurality of times. The rod integrator 111 may be a solid rod or may be a hollow rod the inner wall of which is a mirror surface.

The light (white light) coming out from the rod integrator 111 passes through the relay lenses 120, 123, is reflected by the folding mirror 124, passes through the field lens 125, and becomes incident on the total reflection prism 126.

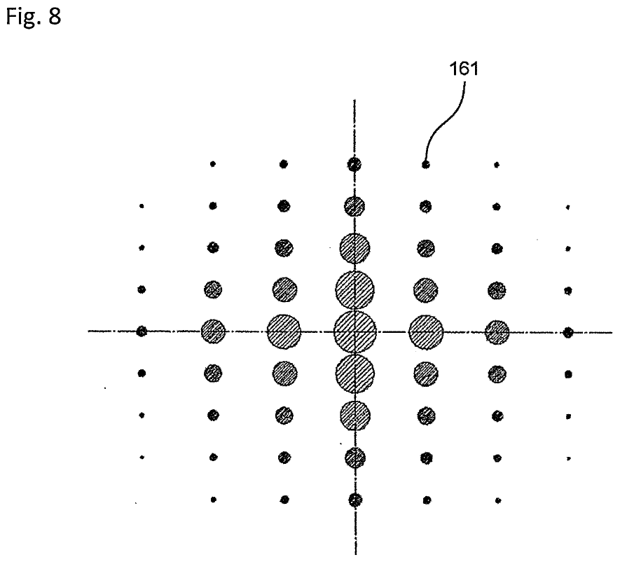

As an example of the light quantity adjustment device according to the present disclosure, a light quantity adjustment device 121 is disposed between the two relay lenses 120, 123, the light quantity adjustment device 121 having a variable aperture at its center. The light quantity adjustment device 121 may also be referred to as a diaphragm device. The light quantity adjustment device 121 is at the pupil of the relay system (the position where the image of the light source is formed by the relay lens 120). The light quantity adjustment device 121 may also be positioned near the pupil. As illustrated in FIG. 8, which will be described later, the position of the light quantity adjustment device 121 may be shifted in the front-back direction along the optical axis with respect to the position of the pupil, as long as it can be recognized that a spot is formed by the distribution of the light. In the light quantity adjustment device 121, the aperture diameter is set so as to determine the quantity of light transmitted through the light quantity adjustment device 121. The light quantity adjustment device 121 includes a stepping motor 122 that operates to change the aperture diameter.

The total reflection prism 126 causes the incident white light to go through a total reflection inside the total reflection prism 126, and outputs the white light toward the color prism device 131. Specifically, the light incident on the total reflection prism 126 goes through a total reflection on a first surface 129, passes through a second surface 130, and becomes incident on the color prism device 131.

The color prism device 131 includes a first prism 133, a second prism 135, and a third prism 136. The first prism 133 has a first dichroic mirror surface 132 having a characteristic for reflecting blue light, and the second prism 135 has a second dichroic mirror surface 134 having a characteristic for reflecting red light.

The image forming elements (DMDs) 137R, 137G, and 137B are disposed on the surfaces of these respective prisms. The DMDs 137R, 137G, and 137B are arranged two-dimensionally, and each of the DMDs 137R, 137G, and 137B has a plurality of micromirrors each corresponding to one pixel. By changing the angles of the micromirrors in accordance with an external signal, the DMDs 137R, 137G, and 137B switch to either direct or not direct the light reflected thereby to the projection lens 138. The light directed to the projection lens 138 passes through the total reflection prism 126, becomes incident on the projection lens 138, and is projected to the screen.

### [1-2. Configuration of Light Quantity Adjustment Device]

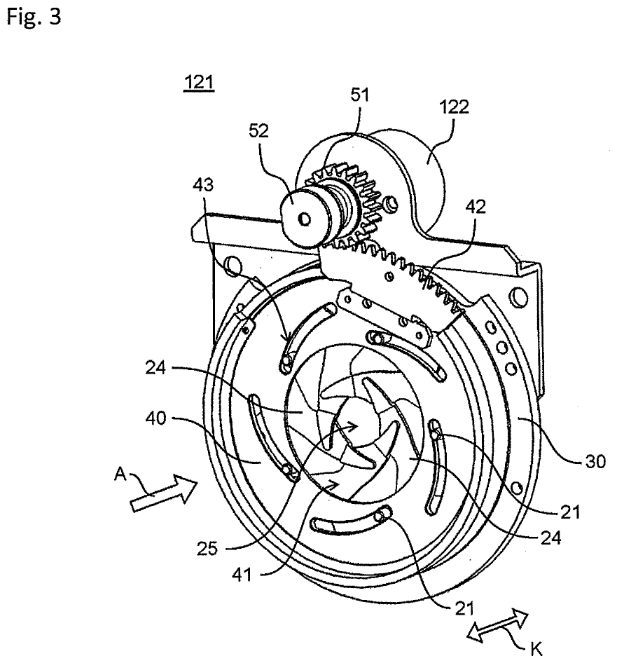

A configuration of the light quantity adjustment device 121 will now be described. FIG. 3 is a perspective view of the light quantity adjustment device 121. FIG. 4 is an exploded view for explaining some of the components of the light quantity adjustment device 121.

As illustrated in FIGS. 3 and 4, the light quantity adjustment device 121 includes a plurality of blade substrates 24, a case member 30, a cam member 40, and the stepping motor 122.

### <Blade Substrates>

The blade substrates 24 are plate-like members for shielding the incident light. The plurality of blade substrates 24 are arranged in a ring-like shape in a manner partially overlapping each other so that an aperture 25 is formed at the center. The aperture diameter of the aperture 25 can be changed by the operation of the blade substrates 24. In this manner, it is possible to limit the quantity of light passed through the light quantity adjustment device 121.

In the present embodiment, the light quantity adjustment device 121 includes five blade substrates 24.

The blade substrates 24 are interposed between the case member 30 and the cam member 40. A direction along which the case member 30, the blade substrates 24, and the cam member 40 are arranged is defined as a thickness direction K.

As illustrated in FIG. 4, each of the plurality of blade substrates 24 is enabled to rotate, with a rotation axis V2 and an actuation axis V1. Specifically, the actuation axis V1 is rotated in a rotating direction S1 about the rotation axis V2, and the blade substrate 24 is thus rotated forwardly and reversely about the rotation axis V2. Each of the blade substrates 24 is provided with an actuation pin 21 and a pin opening 22. The actuation pin 21 is a member engaged with the cam member 40, and defines the actuation axis V1. Into the pin opening 22, a rotation pin (a rotation pin 32 to be described later) provided to the case member 30 is inserted, and the pin opening 22 defines the rotation axis V2. In this manner, the blade substrate 24 is enabled to rotate about the pin opening 22 by the rotation of the actuation pin 21 in the rotating direction S1.

Each of the blade substrates 24 has a plurality of sections (sections R1 to R3, to be described later) divided by offsets. The adjacent blade substrates 24 overlap each other in the sections having different amount of offsets.

### <Case Member>

The case member 30 is a member that defines the rotation axes V2. The case member 30 supports each of the blade substrates 24 rotatably about the corresponding rotation axis V2. The case member 30 delineates a first center aperture (hereinafter, an exit aperture 31) through which light exits. The exit aperture 31 is positioned at or near the center of the case member 30.

The case member 30 defines the positions of the respective rotation axes V2 along the circumferential direction of the exit aperture 31. Specifically, the case member 30 has a plurality of rotation pins 32, protruding from an inner principal surface 30A facing the blade substrate 24, toward the blade substrate 24 in the thickness direction K, and each of the rotation pins 32 defines the rotation axis V2.

The case member 30 engages with the base-end sides of the respective blade substrates 24, via the respective rotation axes V2. Each of the rotation pins 32 of the case member 30 are inserted into the pin openings 22, provided to the respective blade substrates 24. The blade substrates 24 rotate about the respective rotation pins 32.

The case member 30 is fixed to the projection image display device 100.

In the description herein, when a certain section is nearer to the rotation axis V2 than the other sections, the certain section will be described as being on the base-end side with respect to the other section. When a certain section is farther away from the rotation axis V2 than the other sections, the certain section will be described as being on the tip-end side with respect to the other sections. More specifically, being “positioned on the tip-end side” means that a part of a certain section is positioned farther away from the rotation axis V2, than all of the other sections of the blade substrate 24. The “tip end” may be a farthest end of the blade substrate 24, being farthest away from the rotation axis V2 in the linear distance, and the “base end” may be a nearest end of the blade substrate 24, being nearest to the rotation axis V2 in the linear distance.

### <Cam Member>

The cam member 40 is a member that defines the actuation axes V1. The cam member 40 supports the blade substrates 24 rotatably on the respective actuation axes V1. The cam member 40 also delineates a second center aperture (hereinafter, an entrance aperture 41) through which the light enters, at the center of the cam member 40. The entrance aperture 41 is positioned at or near the center of the cam member 40. An aperture 25 formed by the blade substrates 24 connects the entrance aperture 41 and the exit aperture 31, and the entrance aperture 41 thus forms an aperture allowing the light to pass therethrough, with the apertures 25, 31. When the blade substrates 24 take up a larger area of the entrance aperture 41, the quantity of light coming out of the exit aperture 31 is reduced, and the diaphragm size is increased.

The cam member 40 is provided in a manner rotatable with respect to the case member 30 about the center of the entrance aperture 41. In other words, the cam member 40 is provided in a manner rotatable about an optical axis passing through the entrance aperture 41. Specifically, a fan-shaped gear 42 that is meshed with the stepping motor 122 is fixed to a part of the outer periphery of the cam member 40. When the stepping motor 122 operates, the fan-shaped gear 42 is carried with respect to the case member 30, and causes the cam member 40 to rotate.

The cam member 40 is engaged with the plurality of blade substrates 24 via the respective actuation axes V1. The cam member 40 has a plurality of cam grooves 43 along the circumferential direction of the entrance aperture 41. Each of the cam grooves 43 is a groove extending in a direction intersecting with the rotating direction of the cam member 40. Each of the actuation pins 21 provided on the respective blade substrates 24 comes into contact with the inner side of the corresponding cam groove 43. As the cam member 40 is rotated, the actuation pins 21 are moved along the respective cam grooves 43, and rotate about the respective rotation axes V2. The plurality of blade substrates 24 can change the amount by which the exit aperture 31 is shielded by being caused to rotate by the rotation of the actuation pins 21, which follows the rotation of the cam member 40. In other words, the plurality of blade substrates 24 are rotated so as to change the aperture diameter of the aperture 25.

### <Stepping Motor>

The stepping motor 122 includes a gear 51 and a slip clutch mechanism 52. The gear 51 is a member that rotates forwardly and reversely as the stepping motor 122 operates. The gear 51 is engaged with the fan-shaped gear 42 provided to the cam member 40, via the slip clutch mechanism 52. With such a structure, the cam member 40 is rotated as the gear 51 is rotated.

The light quantity adjustment device 121 receives light in a direction indicated by the arrow A. When a part of the light output in the direction of the arrow A hits the blade substrates 24, less light passes through the aperture 25 and the exit aperture 31. By adjusting the aperture diameter of the aperture 25, the light quantity adjustment device 121 can adjust the quantity of light passed through the aperture 25.

A structure of each of the blade substrates 24 will now be described in detail.

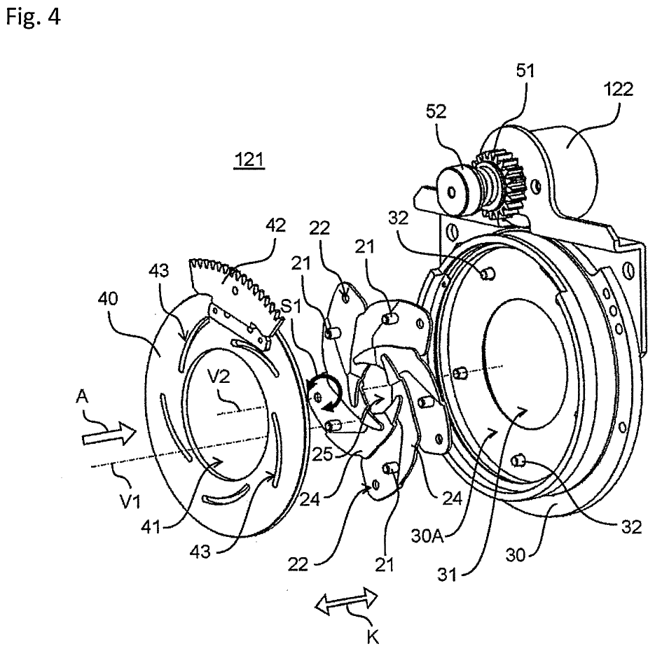

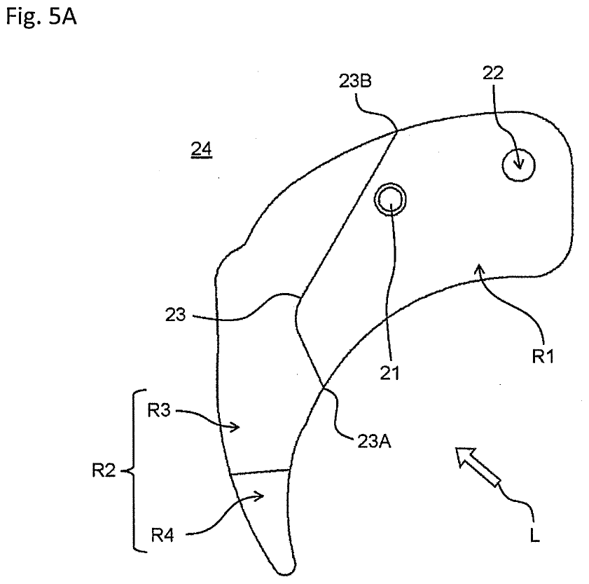

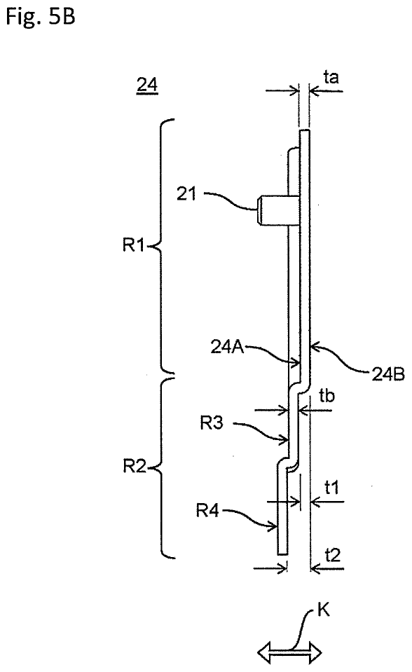

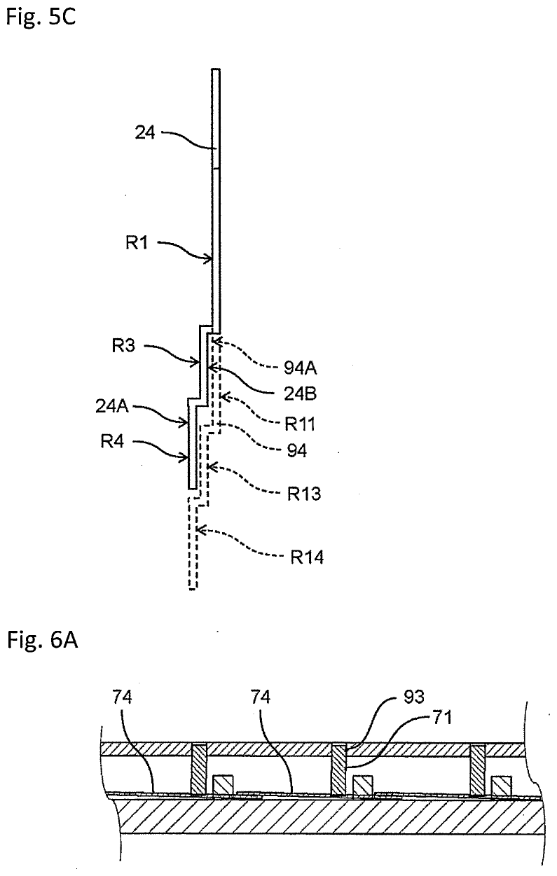

FIG. 5A is a plan view illustrating one of the blade substrates 24. FIG. 5B is a side view of the blade substrate 24 in a view along the direction of the arrow L illustrated in FIG. 5A.

As illustrated in FIGS. 5A and 5B, the blade substrate 24 is a plate-like member bent in the thickness direction K. The blade substrate 24 therefore has a plurality of sections with different heights in the thickness direction K.

Although one blade substrate 24 will be explained below, the plurality of blade substrates 24 in the present embodiment have a common shape. Note that the plurality of blade substrates 24 may also have different shapes.

As illustrated in FIGS. 5A and 5B, the blade substrate 24 has a first section R1 and a second section R2 that is on the tip-end side of the first section R1.

As illustrated in FIG. 5A, the first section R1 is a section on the base-end side of the blade substrate 24. In the present embodiment, the first section R1 is a section adjacent to the rotation pin 32, the section being a section of the blade substrate 24. More specifically, the first section R1 has a pin opening 22 into which the rotation pin 32 is inserted. In the present embodiment, the first section R1 also has the actuation pin 21.

The second section R2 is a section adjacent to the first section R1, and is on the tip-end side of the first section R1. The second section R2 includes a third section R3 and a fourth section R4 that is on the tip-end side of the third section R3. The third section R3 is adjacent to the first section R1. The fourth section R4 is adjacent to the third section R3, and forms the tip end of the blade substrate 24.

In a plan view, the tip-end side of the blade substrate 24 is smaller in width than the base-end side of the blade substrate 24. Therefore, the fourth section R4 has a triangular shape pointed toward the tip-end side.

As illustrated in FIG. 5B, the sections R1, R3, and R4 of the blade substrate 24 are at different heights in the thickness direction K. In the description herein, a top surface 24A of the blade substrate 24 is a surface facing the cam member 40, and a bottom surface 24B of the blade substrate 24 is a surface facing the case member 30.

The bottom surface 24B of the second section R2 of the blade substrate 24 is provided at a position higher than the top surface 24A of the first section R1 of the blade substrate 24, in the thickness direction K. In other words, there is a first offset between the second section R2 and the first section R1.

The height t1 of the first offset will now be described. The height of an offset means a difference in the height of the bottom surface 24B in the sections prior to and subsequent to the offset. The first section R1 of the blade substrate 24 has a uniform thickness ta, and the second section R2 of the blade substrate 24 has a uniform thickness tb. The first section R1 of the blade substrate 24 is substantially flat. In this condition, the height t1 of the first offset with respect to the bottom surface 24B of the first section R1 is greater than the thickness ta.

In the present embodiment, the thickness ta and the thickness tb are the same, and are 0.5 mm, for example. The thicknesses ta and tb may include errors due to factors such as machining accuracy, and may be substantially constant.

The bottom surface 24B of the fourth section R4 of the blade substrate 24 is provided at position higher than the top surface 24A of the third section R3 of the blade substrate 24, in the thickness direction K. In other words, there is a second offset between the fourth section R4 and the third section R3.

The height t2 of the second offset will now be described. The sections R3, R4 of the blade substrate 24 are substantially flat. In this condition, the height t2 of the second offset with respect to the height t1 of the first offset, which corresponds to the bottom surface 24B of the third section R3, is greater than the thickness tb. The height t2 of the second offset with respect to the bottom surface 24B of the first section R1 is greater than the height t1+tb that is the sum of the height t1 of the first offset and the thickness tb.

Summarizing the height relationships, the following expressions (1) and (2) are established.

$$t 1 > ta \qquad ( 1 )$$

$$t 2 > t 1 + tb > ta + tb \qquad ( 2 )$$

The blade substrate 24 is formed by applying bending in accordance with the height relationship described above.

Returning to FIG. 5A, a boundary line 23 between the second section R2 and the first section R1 extends between a first end 23A and a second end 23B. The first end 23A is on the inner edge of the blade substrate 24, the inner edge being an edge facing the exit aperture 31. The second end 23B is on the outer edge of the blade substrate 24, the outer edge being an edge facing away from the center of the exit aperture 31. The first end 23A is on the tip-end side, with respect to the second end 23B. With such a structure, a larger area is ensured on the inner side of the first section R1 so that a larger area is ensured for another blade substrate 24 to overlap with the first section R1 from the inner side.

The boundary line 23 may extend along a curved line so that the area of the first section R1 is increased. With such a structure, a larger area of the first section R1 can be ensured, compared with a structure in which the boundary line 23 is a straight line.

A way in which the plurality of blade substrates 24 overlap each other will now be described.

FIG. 5C is a schematic illustrating two blade substrates 24, 94. As illustrated in FIG. 5C, the blade substrate 24 overlaps with the blade substrate 94 that is adjacent thereto. More specifically, the third section R3 of the blade substrate 24 and the first section R11 of the blade substrate 94 overlap with each other, and the fourth section R4 of the blade substrate 24 and the third section R13 of the blade substrate 94 overlap with each other. Meanwhile, the fourth section R4 of the blade substrate 24 and the fourth section R14 of the blade substrate 94 remain exposed. Because the bottom surface 24B of the third section R3 and the fourth section R4 of the blade substrate 24 are higher than the top surface 94A of the first section R11 and the third section R13 of the blade substrate 94, respectively, the blade substrate 24 can avoid interference with the blade substrate 94.

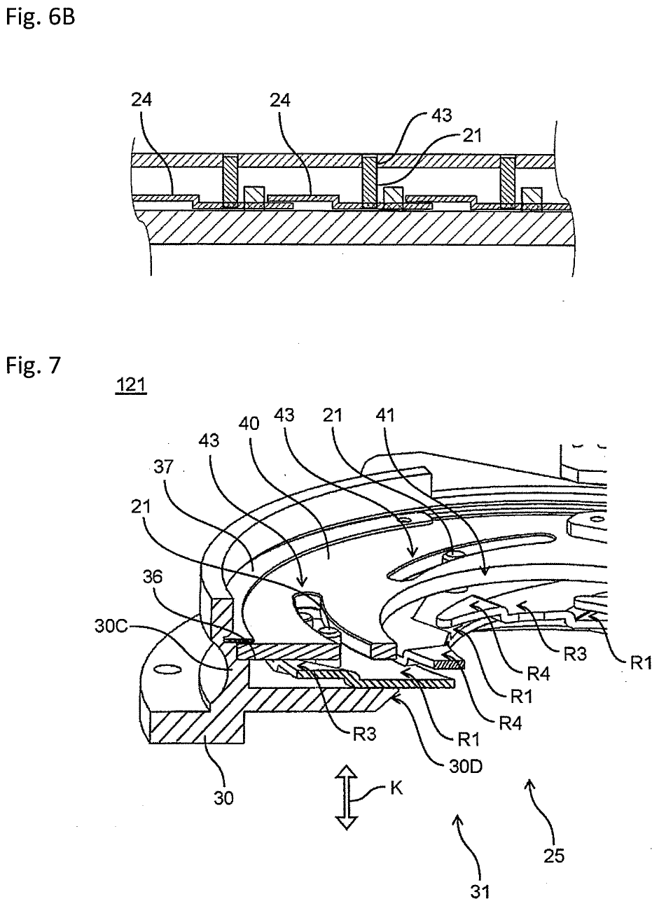

In order to further clarify the effect of the present disclosure, the light quantity adjustment device 121 of the present disclosure will be compared with a conventional counterpart. FIG. 6A is a schematic of a conventional light quantity adjustment device. FIG. 6B is a schematic of the light quantity adjustment device 121 according to the present disclosure.

As illustrated in FIG. 6A, a conventional blade substrate 74 is a thin and flat plate. Because the blade substrate 74 is thin, it is possible to suppress slanting of the blade substrate 74 even while the blade substrate 74 is on top of another blade substrate 74, and therefore, it is possible to suppress tilting of the actuation pins 71. By contrast, if the thickness of the blade substrate 74 is to be increased in such a configuration, the blade substrate 74 and the actuation pin 71 become more slanted when the blade substrate 74 is on top of another blade substrate 74, and the actuation pin 71 and the cam groove 93 gall each other and cause malfunction. Therefore, in such a configuration, it is difficult to use a blade substrate thicker than 0.1 mm.

As illustrated in FIG. 6B, in the light quantity adjustment device 121 of the present disclosure, by providing an appropriate clearance by bending, it is possible to prevent interference between the blade substrates 24. With such a structure, it is possible to suppress slanting of the blade substrate 24, and the actuation pins 21 are allowed to move along the respective cam grooves 43.

FIG. 7 is a perspective view illustrating a partial cross section of the light quantity adjustment device 121. As illustrated in FIG. 7, because each of the blade substrates 24 has the sections R1, R3, and R4 operating at offset levels, the blade substrates 24 are allowed to overlap each other without interfering each other.

Therefore, the rotating operations of the blade substrates 24 can be ensured regardless of the thickness of the blade substrate 24. The thickness of the blade substrate 24 may be 0.1 mm or less, which has been used conventionally, or may be 0.1 mm or more.

By increasing the thickness of the blade substrate 24, the thermal conductivity of the blade substrate 24 can be improved. In addition, a material with a thickness limitation can be used for the blade substrate 24.

The material of the blade substrate 24 will now be described more in detail. The blade substrate 24 is formed of a material that is reflective rather than absorptive. By using such a material, even when strong light from the light source is guided into the light quantity adjustment device 121, and the blade substrates 24 receive a part of the strong light, it is possible to suppress deformation of the blade substrates 24.

Furthermore, the blade substrate 24 is formed of a material having excellent light resistance, thermal conductivity, and heat dissipating property. The blade substrate 24 may be formed of aluminum or copper, for example. For example, the blade substrate 24 is an aluminum member having a thickness of 0.4 mm or more (e.g., 0.5 mm).

Furthermore, one surface of the blade substrate 24, that is, the incident surface thereof may exhibit a characteristic that diffusely reflects light. This characteristic of diffusely reflecting light prevents the light having reflected on the nearby elements from having a light density necessary to become a heat source. The characteristics of diffusely reflecting light can be achieved by, for example, applying surface processing such as satin finishing or embossing. By applying such surface processing to the incident-side surface of the blade substrate 24, the blade substrate 24 can achieve the light quantity adjustment function even if incident light becomes incident from a direction of the arrow A in FIG. 4.

A relationship between the case member 30 and the cam member 40 will now be described. The case member 30 holds the cam member 40. Specifically, as illustrated in FIG. 7, the case member 30 has a side wall 30C, and the side wall 30C has a groove 36 along over the entire circumference thereof. Above the groove 36, a holding member 37 facing the groove 36 in the thickness direction K is provided. The cam member 40 is disposed inside the groove 36 and is sandwiched between the side wall 30C and the holding member 37 of the case member 30. In this manner, the case member 30 and the cam member 40 together form a housing that houses the blade substrates 24.

The area of the opening of the exit aperture 31 becomes larger in the thickness direction K from the cam member 40 toward the case member 30. A side surface 30D forming the exit aperture 31 has a tapered shape becoming larger in a direction separating from the cam member 40.

FIG. 8 illustrates an example of light source images 161 formed in the relay system. By using the material described above or applying surface processing, even when the light source images 161 are formed discretely as illustrated in FIG. 8, so that the light becomes collected locally and generates heat, it is possible to suppress burning of the blade substrates 24.

### (Operation)

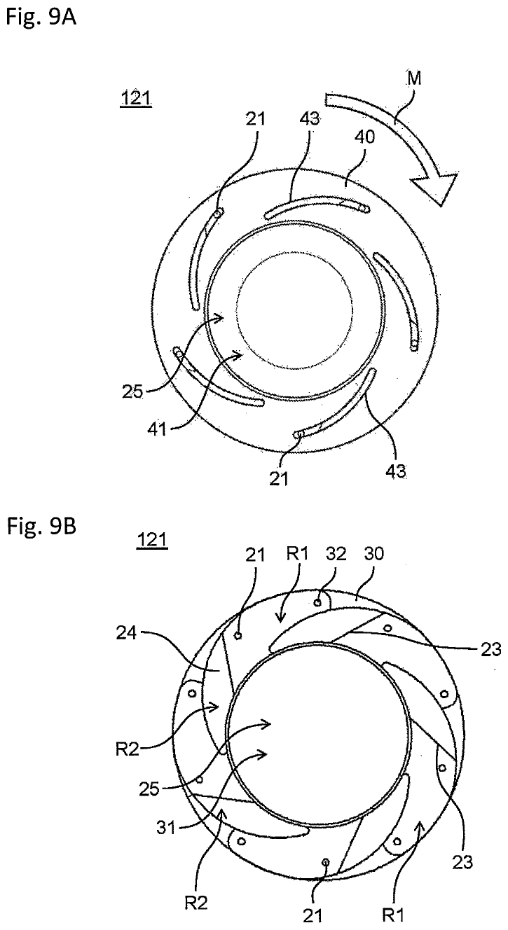

An example of an operation performed by the light quantity adjustment device 121 having the configuration described above will now be described with reference to FIGS. 9A to 10B. FIGS. 9A and 9B are schematics illustrating the blade substrates 24 of the light quantity adjustment device 121 at a housing position. FIGS. 10A and 10B are schematics illustrating the blade substrates 24 of the light quantity adjustment device 121 at a stopping position. In FIGS. 9A to 10B, for simplicity, the second section R2 is illustrated as a section having a constant height. In FIGS. 9A and 10A, the cam member 40 is illustrated, and in FIGS. 9B and 10B, the cam member 40 is omitted.

As illustrated in FIG. 9A, when the blade substrates 24 are at the housing position, the entire entrance aperture 41 and exit aperture 31 communicate with each other. The blade substrates 24 are completely housed between the cam member 40 and the case member 30. Each of the actuation pins 21 on the blade substrates 24 are positioned at one end of the respective cam grooves 43. As illustrated in FIG. 9B, in the housing position, the second sections R2 of the plurality of respective blade substrates 24 partially overlap with the first sections R1 of respective adjacent blade substrates 24.

When the stepping motor 122 operates, the cam member 40 is caused to rotate in the direction of the arrow M.

As illustrated in FIG. 10A, as the cam member 40 is rotated, the actuation pins 21 on the respective blade substrates 24 are caused to move from the one ends to the other ends of the cam grooves 43, respectively. As a result, the blade substrates 24 protrudes out of the space between the cam member 40 and the case member 30 toward the center of the entrance aperture 41. The blade substrates 24 come to the stopping position and blocks a part of the entrance aperture 41 and the exit aperture 31. As illustrated in FIG. 10B, at the stopping position, the second sections R2 of the plurality of respective blade substrates 24 partially overlap with the first sections R1 of the respective blade substrates 24 that are adjacent thereto. The tip end of each of the blade substrates 24 at the stopping position is nearer to the boundary line 23 of the adjacent blade substrate 24 than that at the housing position.

When the stepping motor 122 is caused to operate in the reverse direction, the cam member 40 is caused to rotate in the direction opposite to the direction of the arrow M (FIG. 9A), and the blade substrates 24 are returned to the housing position.

Although the two positions of the housing position and the stopping position have been described, the blade substrate 24 may take any position between the housing position and the stopping position, by stopping the stepping motor 122 somewhere in between.

### Advantageous Effects

With the light quantity adjustment device 121 according to this embodiment, it is possible to achieve the following advantageous effects.

The light quantity adjustment device 121 according to the present embodiment includes the plurality of blade substrates 24, the case member 30 (first member), and the cam member 40 (second member), as described above. Each of the plurality of blade substrates 24 is enabled to rotate with the rotation axis V2 and the actuation axis V1. The case member 30 forms the exit aperture 31, and defines the positions of the rotation axes V2 along the circumferential direction of the exit aperture 31. The base-end sides of the plurality of blade substrates 24 are engaged with the case member 30 via the respective rotation axes. The cam member 40 sandwiches the plurality of blade substrates 24 between the case member 30, forms the entrance aperture 41 communicating with the exit aperture 31, and is engaged with the plurality of blade substrates via the actuation axes V1. The plurality of blade substrates 24 are enabled to rotate, as the cam member 40 is rotated, between the housing position and the stopping position where the exit aperture 31 is shielded more than that at the housing position. The blade substrate 24 has the first section R1 and the second section R2 that is on the tip-end side of the first section R1. The bottom surface 24B of the second section R2 of the blade substrate 24 is provided at a position higher than the top surface 24A of the first section R1 of the blade substrate 24, in the thickness direction K. When viewed from the thickness direction K, at least at the stopping position, the second sections R2 of the plurality of respective blade substrates 24 partially overlap with the first sections R1 of the respective blade substrates 24 that are adjacent thereto.

With such a configuration, by changing the heights of the sections R1 and R2, the blade substrates 24 are allowed to rotate even while the first section R1 of a certain blade substrate 24 and the second section R2 of the blade substrate 24 adjacent thereto are overlapping each other. By permitting the rotations of the blade substrates 24 regardless of the thicknesses ta and tb of each of the blade substrates 24, the blade substrate 24 can be designed to have any thicknesses ta and tb. Therefore, heating and burning of the blade substrates 24 can be suppressed by increasing the thicknesses ta and tb.

In the light quantity adjustment device 121 according to the embodiment, the second section R2 includes the third section R3 and the fourth section R4 that is on the tip-end side of the third section R3. The bottom surface 24B of the fourth section R4 of the blade substrate 24 is provided at position higher than the top surface 24A of the third section R3 of the blade substrate 24, in the thickness direction K. In a view in the thickness direction K, at least at the stopping position, the fourth sections R4 of the plurality of respective blade substrates 24 partially overlap with the third sections R3 of the respective blade substrates 24 that are adjacent thereto.

With such a configuration, the third sections R3 of the plurality of respective blade substrates 24 are allowed to overlap with the fourth sections R4 of the respective blade substrates 24 that are adjacent thereto. Therefore, the adjacent blade substrates 24 overlap each other by a wider area, and the area of the diaphragm can be increased.

In the light quantity adjustment device 121 according to the embodiment, the first section R1 of the blade substrate 24 and the second section R2 of the blade substrate 24 have uniform thicknesses ta, tb, respectively.

With such a configuration, it becomes easier to design the offsets on the blade substrate 24. In addition, the blade substrate 24 can be easily manufactured from a single plate member.

In the light quantity adjustment device 121 according to the present embodiment, the boundary line 23 between the first section R1 and the second section R2 of the blade substrate 24 extends between the first end 23A that is on the inner edge facing the exit aperture 31 and the second end 23B that is on the outer edge that faces away from the exit aperture 31. The first end 23A is positioned on the tip-end side, with respect to the second end 23B.

With such a configuration, as compared with a configuration in which the boundary line 23 is provided oppositely (i.e. the second end 23B is positioned on the tip-end side with respect to the first end 23A), a wider area for the other blade substrate 24 to overlap can be ensured on the inner side. Therefore, the adjacent blade substrates 24 overlap each other by a wider area, and the area of the diaphragm can be increased.

In the light quantity adjustment device 121 according to this embodiment, the plurality of blade substrates 24 have a common shape.

With such a configuration, designing of the light quantity adjustment device 121 can be simplified.

In the light quantity adjustment device 121 according to this embodiment, each of the plurality of blade substrates 24 is made of an aluminum material having a thickness of 0.4 mm or more.

With such a configuration, burning and deformation of the blade substrate 24 can be suppressed by increasing the thickness. In addition, with the use an aluminum material, heat dissipation and thermal conductivity of the blade substrate 24 can be improved. Therefore, heating and burning of the blade substrate 24 can be further suppressed.

In the light quantity adjustment device 121 according to this embodiment, one surface of the blade substrate 24 exhibits a characteristic diffusely reflecting light.

With such a configuration, it is possible to suppress the one surface of the blade substrate 24 from becoming a heat source. Therefore, heating and burning of the blade substrate 24 can be further suppressed.

In the light quantity adjustment device 121 according to the present embodiment, the area of opening of the exit aperture 31 increases in the thickness direction K, from the cam member 40 toward the case member 30.

With such a configuration, emission of light can be promoted.

The projection image display device 100 according to this embodiment includes the light quantity adjustment device 121 at or near a pupil position, on the light path of illumination light.

With such a configuration, also in the projection image display device 100 that uses a high power light source, both of the contrast and the brightness of the image can be adjusted using the light quantity adjustment device 121.

In the projection image display device 100 according to this embodiment, an incident surface of the blade substrate 24 exhibits a characteristic diffusely reflecting light in the light path.

With such a configuration, it is possible to suppress the incident surface, which receives more light, from becoming a heat source. Therefore, heating and burning of the blade substrate 24 can be further suppressed.

Note that in the example described in the first embodiment, the light quantity adjustment device 121 includes the stepping motor 122, but the present disclosure is not limited thereto. The light quantity adjustment device 121 may be operated manually.

In the example described in the first embodiment, the actuation pin 21 is provided on the first section R1, but the present disclosure is not limited thereto. The actuation pin 21 may be provided on another section. The actuation pin 21 may be provided on any section other than the section interfering with the other blade substrate 24. In addition, the actuation pins may be provided to the cam member 40, and openings corresponding to the respective actuation pins may be provided on the blade substrates 24, respectively.

In the example described in the first embodiment, the thicknesses ta, tb are uniform, but the present disclosure is not limited thereto. For example, the sections R1, R3 of the blade substrate 24 may have different thicknesses as long as the expressions (1) and (2) are satisfied. The fourth section R4 may have any thickness because there is no other section overlapping with the fourth section R4. By using constant thicknesses ta and tb, by contrast, the blade substrate 24 can be easily manufactured by bending one plate.

In the example described in the first embodiment, the entrance aperture 41 and the exit aperture 31 entirely communicate with each other when the blade substrate 24 is at the housing position, but the present disclosure is not limited thereto. For example, the blade substrates 24 may partly overlap with the entrance aperture 41 at the housing position, too.

In the example described in the first embodiment, the blade substrate 24 has the three sections R1, R3, and R4 having different heights, but the present disclosure is not limited thereto. For example, the blade substrate 24 may have another section that is different from the sections R1, R3, and R4, as will be illustrated later in first to third modifications. Furthermore, as will be illustrated later in a fourth modification, the height of the second section R2 may be constant.

In the example described in the first embodiment, the rotation axes V2 are provided to the case member 30, but the present disclosure is not limited thereto. For example, as will be illustrated later in a fifth modification, the rotation axes V2 may be provided on the blade substrates 24.

### (First Modification)

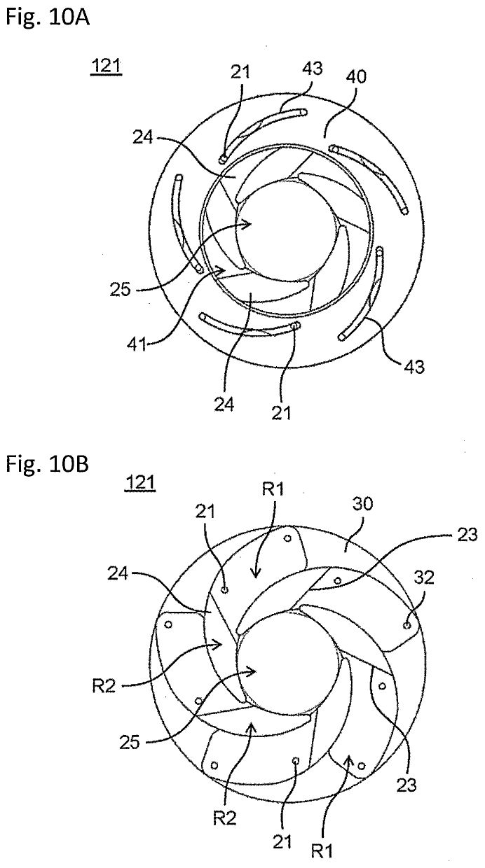

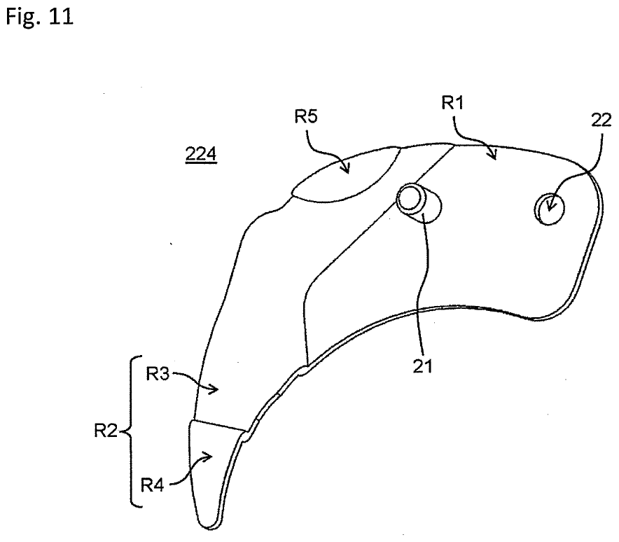

FIG. 11 is a perspective view of a blade substrate 224 including a support section R5. As illustrated in FIG. 11, the blade substrate 224 has the support section R5, in addition to the first section R1 and the second section R2. The support section R5 is provided in an area at least partially overlapping with the cam member 40 in the thickness direction K, between the housing position and the stopping position, and is a section enabled to come into contact with the cam member 40. In other words, regardless of the orientation of the blade substrate 224, the support section R5 can come into contact with the cam member 40. The support section R5 may be provided in a manner facing the outer edge of the blade substrate 224.

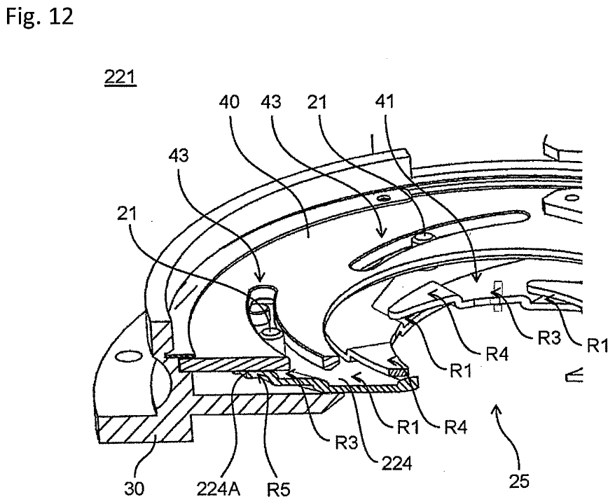

FIG. 12 is a perspective view illustrating a partial cross section of a light quantity adjustment device 221. As illustrated in FIG. 12, the height of the support section R5 is larger than the height of the first section R1. The height of the support section R5 may be larger than the height of the third section R3. In this embodiment, the support section R5 has substantially the same height as the fourth section R4.

The top surface 224A of the support section R5 of the blade substrate 224 is enabled to come into contact with the cam member 40. With the support section R5 in contact with the cam member 40, the blade substrate 224 can be suppressed from separating from the cam member 40 and the case member 30 and becoming unstable. Furthermore, the blade substrate 224 can be suppressed from detaching from between the cam member 40 and the case member 30.

At the same time, there may be a gap between the top surface 224A of the support section R5 of the blade substrate 224 and the cam member 40. With such a structure, slidability of the blade substrate 224 can be ensured.

The support section R5 may also be formed of a member separate from the blade substrate 224. Such a configuration makes it easy to manufacture the blade substrate 224.

### (Second Modification)

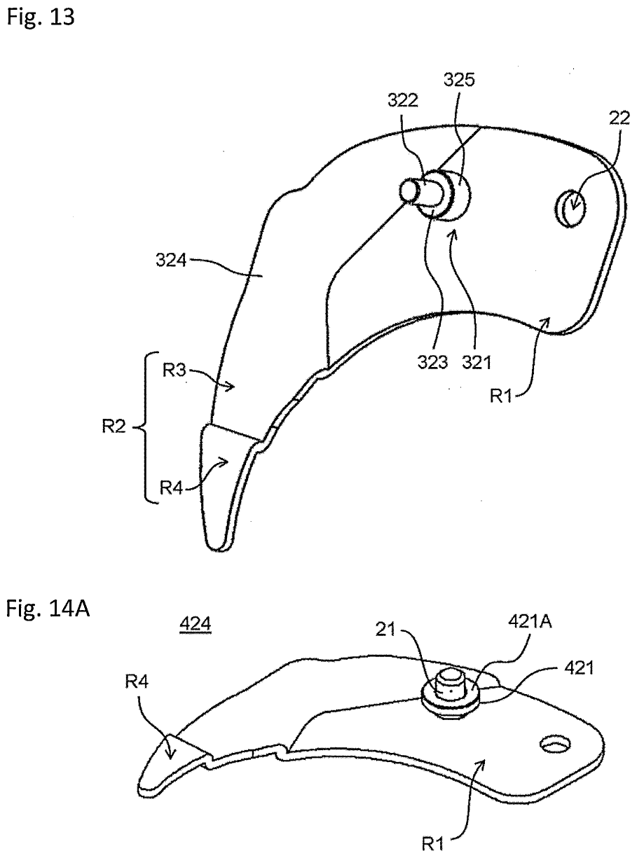

FIG. 13 is a perspective view of a blade substrate 324 provided with an actuation pin 321. The blade substrate 324 has multi-levelled actuation pins 321, instead of the actuation pins 21. The multi-levelled actuation pin 321 defines the actuation axis V1, and is integrally fixed to the blade substrate 324. The multi-levelled actuation pin 321 has a small diameter portion 322 on the tip end and a thick portion 325 on the base end. The diameter of the small diameter portion 322 is smaller than the size of the cam groove 43, and the diameter of the thick portion 325 is larger than the size of the cam groove 43. Between the small diameter portion 322 that is on the tip end and the thick portion 325, there is an intermediate surface 323 that faces the cam member 40. The height of the intermediate surface 323 is larger than the height of the first section R1. The height of the intermediate surface 323 may be larger than the height of the third section R3. In the present embodiment, the intermediate surface 323 is at substantially the same height as the fourth section R4.

The intermediate surface 323 is a surface that can come into contact with the cam member 40 around the cam groove 43. There may be a gap between the intermediate surface 323 and the cam member 40.

With the intermediate surface 323 in contact with the cam member 40, the blade substrate 324 can be suppressed from separating from the cam member 40 and the case member 30 and becoming unstable. Furthermore, the blade substrate 324 can be suppressed from detaching from between the cam member 40 and the case member 30.

### (Third Modification)

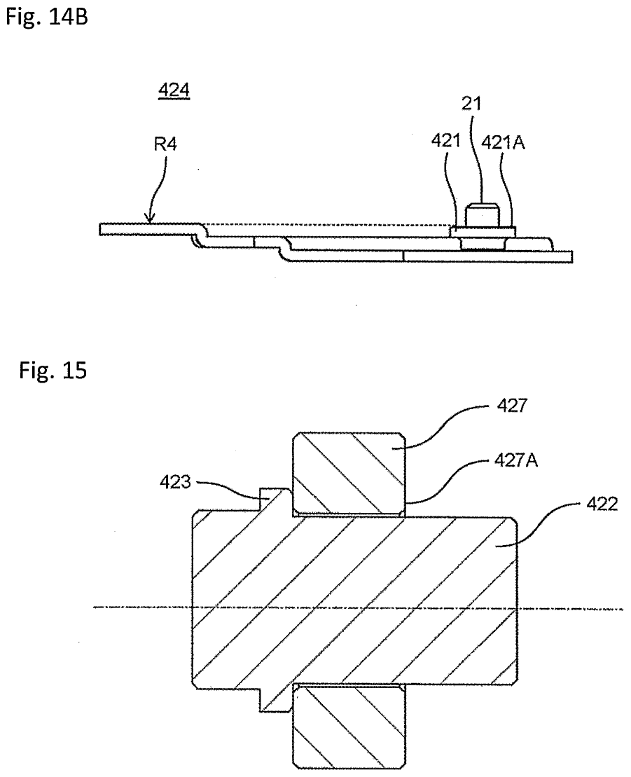

FIGS. 14A and 14B are perspective views of a blade substrate 424 provided with an actuating roller 421. As illustrated in FIGS. 14A and 14B, the blade substrate 424 includes the actuating roller 421 provided around the actuation pin 21. The actuating roller 421 has a top surface 421A at a height higher than the height of the first section R1. The top surface 421A may be at the same height as the fourth section R4. The actuating roller 421 is spaced apart from the surface of the blade substrate 424 so as to avoid interference between the actuating roller 421 and another blade substrate 424.

FIG. 15 is a cross-sectional view illustrating an application example of the configuration of the actuation pin 21 including the actuating roller 421. As illustrated in FIG. 15, a seated actuation pin 422 has a seat 423 on the part coming into contact with the surface of the blade substrate 424, and holds the roller 427. This configuration can replace the configurations illustrated in FIGS. 14A and 14B by setting the top surface 427A of the roller 427 to the same height as the top surface 421A of the actuating roller 421.

### (Fourth Modification)

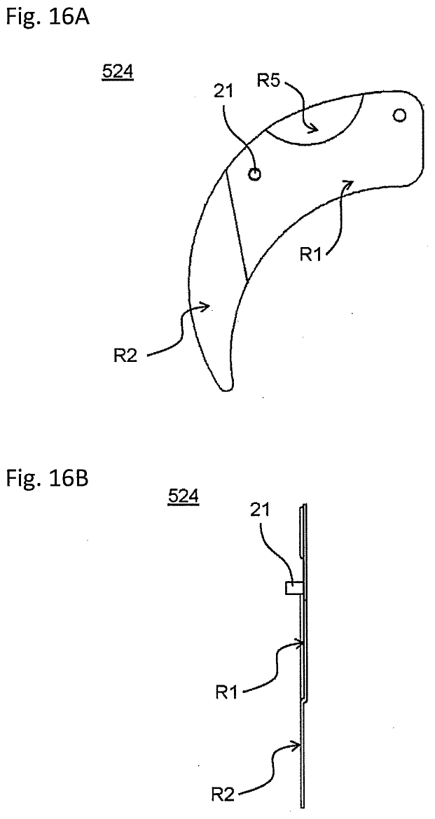

FIGS. 16A and 16B are schematics illustrating a blade substrate 524 having the support section R5. As illustrated in FIGS. 16A and 16B, the blade substrate 524 has the support section R5, in addition to the first section R1 and the second section R2. The second section R2 has a substantially constant height. The support section R5 has a height equal to or higher than the first section R1, and may have substantially the same height as the second section R2.

In the blade substrate 524, a multi-levelled actuation pin 321 or the actuation pin 21 including the actuating roller 421 may be used, instead of the support section R5. In such a case, the intermediate surface 323 and the top surface 421A may be at a height equal to or higher than the first section R1, and may be at substantially the same height as the second section R2.

### (Fifth Modification)

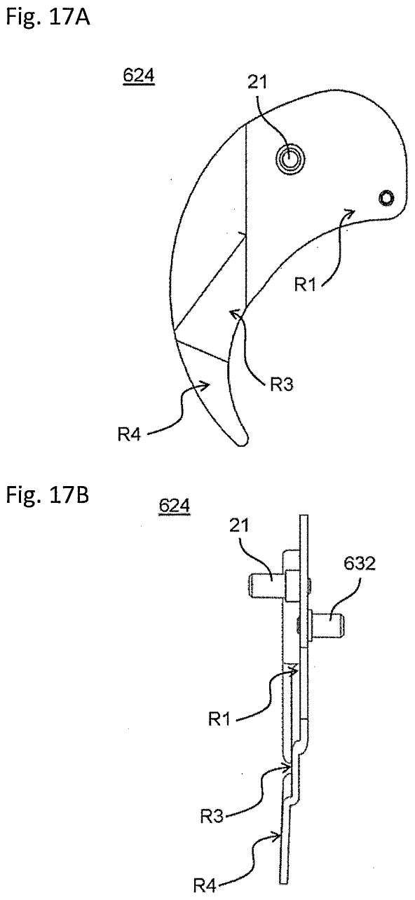

FIGS. 17A and 17B are schematics illustrating a blade substrate 624 including a rotation pin 632. As illustrated in FIG. 17B, the rotation pin 632 may be provided to the blade substrate 624, instead of being provided to the case member 30. In such a case, the case member 30 is provided with openings corresponding to the rotation pins 632.

### Second Embodiment

A light quantity adjustment device according to a second embodiment of the present disclosure will now be explained. In the second embodiment, differences with respect to the first embodiment will be mainly explained. In the second embodiment, the same or equivalent elements as those according to the first embodiment will be explained by assigning the same reference numerals thereto. In the second embodiment, descriptions that are redundant with those in the first embodiment will be omitted.

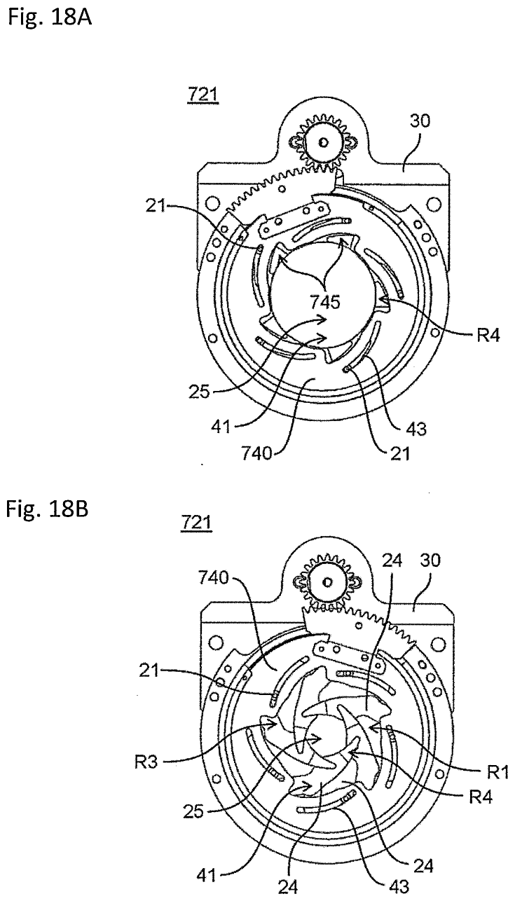

FIGS. 18A and 18B are schematics of a light quantity adjustment device 721 according to the second embodiment of the present disclosure. FIG. 18A illustrates the light quantity adjustment device 721 at the housing position, and FIG. 18B illustrates the light quantity adjustment device 721 at the stopping position.

The second embodiment is different from the first embodiment in that a cam member 740 has a different structure.

As illustrated in FIG. 18A, the cam member 740 has fitting holes 745 communicating with the entrance aperture 41 within a range corresponding to the respective fourth sections R4 of the blade substrates 24 at the housing position. Each of the fitting holes 745 may cover an area larger than the fourth section R4 so that the entire fourth section R4 is exposed.

When FIGS. 18A and 18B are considered together, the fourth sections R4 of the respective blade substrates 24 do not overlap with the cam member 740 at the housing position, the stopping position, or any position therebetween. With such a configuration, interference between the blade substrate 24 and the cam member 740 across the fourth sections R4 can be avoided. In this manner, it becomes possible to alleviate wearing the fourth section R4 of the blade substrate 24 and the cam member 40 due to the repeated use.

The fitting holes 745 may also be provided to the area corresponding to the second section R2 of the blade substrate 24, that is, to the area corresponding to the third section R3 and the fourth section R4, at the housing position.

A light quantity adjustment device of a first aspect includes a plurality of blade substrates that are each provided rotatably with a rotation axis and an actuation axis; a first member that has a first center aperture, defines positions of the rotation axes along a circumferential direction of the first center aperture, and engages with base-end sides of the plurality of blade substrates via the rotation axes; and a second member that sandwiches the plurality of blade substrates between the first member, has a second center aperture communicating with the first center aperture, and engages with the plurality of blade substrates via the actuation axes, wherein the plurality of blade substrates are rotatable as the second member is rotated, between a housing position and a stopping position, where an amount by which the first center aperture is shielded at the stopping position is larger than an amount by which the first center aperture is shielded at the housing position, each of the plurality of blade substrates includes a first section and a second section that is on a tip-end side with respect to the first section, a bottom surface of the second section of the blade substrate is positioned higher in a thickness direction than a top surface of the first section of the blade substrate, and when viewed from the thickness direction, at least at the stopping position, the second section of each of the plurality of blade substrates partially overlaps with the first section of another adjacent one of the plurality of blade substrates.

The light quantity adjustment device of a second aspect, depending on the first aspect wherein the second section includes a third section and a fourth section that is on the tip-end side with respect to the third section, a bottom surface of the fourth section of the blade substrate is at a position higher than a top surface of the third section of the blade substrate in the thickness direction, and in the view in the thickness direction, at least at the stopping position, the fourth section of each of the plurality of blade substrates partially overlaps with the third section of another adjacent one of the plurality of blade substrates.

The light quantity adjustment device of a third aspect, depending on the first or second aspect wherein the first section of the blade substrate and the second section of the blade substrate have a uniform thickness.

The light quantity adjustment device of a fourth aspect, depending on any one of the first to third aspects wherein a boundary line between the first section and the second section extends between a first end and a second end on the blade substrate, the first end being positioned on an inner edge of the blade substrate and facing the first center aperture, and the second end being positioned on an outer edge facing away from the first center aperture, and the first end is positioned on the tip-end side with respect to the second end.

The light quantity adjustment device of a fifth aspect, depending on any one of the first to fourth aspects wherein the plurality of blade substrates have a common shape.

The light quantity adjustment device of a sixth aspect, depending on any one of the first to fifth aspects wherein the blade substrate is provided across a range at least partially overlapping with the second member in the thickness direction, between the housing position and the stopping position, and has a support section enabled to come into contact with the second member, and the support section has a height higher than a height of the first section.

The light quantity adjustment device of a seventh aspect, depending on the sixth aspect wherein the member forming the support section and the blade substrate are separate members.

The light quantity adjustment device of an eighth aspect, depending on any one of the first to seventh aspects wherein an actuation pin defining the actuation axis is integrally fixed to the blade substrate, and has an intermediate surface higher than a height of the first section.

The light quantity adjustment device of a ninth aspect, depending on the second aspect wherein the blade substrate is provided across a range at least partially overlapping with the second member in the thickness direction, between the housing position and the stopping position, and has a support section enabled to come into contact with the second member, and the support section has a height higher than a height of the third section.

The light quantity adjustment device of a tenth aspect, depending on the ninth aspect wherein the member forming the support section and the blade substrate are separate members.

The light quantity adjustment device of an eleventh aspect, depending the second aspect wherein an actuation pin defining the actuation axis is integrally fixed to the blade substrate, and has an intermediate surface higher than a height of the third section.

The light quantity adjustment device of a twelfth aspect, depending on any one of the first to eleventh aspects wherein the blade substrate is an aluminum member having a thickness of 0.4 mm or more.

The light quantity adjustment device of a thirteenth aspect, depending on any one of the first to twelfth aspects wherein one surface of the blade substrate exhibits a characteristic diffusely reflecting light.

The light quantity adjustment device of a fourteenth aspect, depending on any one of the first to thirteenth aspects wherein an opening area of the first center aperture increases in the thickness direction from the second member toward the first member.

The light quantity adjustment device of a fifteenth aspect, depending on any one of the first to fourteenth aspects wherein the second member has a fitting hole communicating with the second center aperture across a range corresponding to the second section of the blade substrate positioned at the housing position.

The projection image display device of a sixteenth aspect includes the light quantity adjustment device according to any one of the first to fifteenth aspects at or near a pupil position, on a light path of illumination light.

The projection image display device of a seventeenth aspect, depending on the sixteenth aspect wherein an incident surface of the blade substrate exhibits a characteristic diffusely reflecting light in the light path.

Although the present disclosure has been fully described in connection with the preferred embodiments thereof with reference to the accompanying drawings, it is to be noted that various changes and modifications are apparent to those skilled in the art. Such variations and modifications are to be understood as falling within the scope of the present disclosure, as set forth in the appended claims.

The present disclosure is applicable to a diaphragm mechanism, and a projection image display device and a projecting video display device using the diaphragm mechanism.

### REFERENCE NUMERALS

100 projection image display device
200 light source device
300 illumination optical system
121 light quantity adjustment device
122 stepping motor
21 actuation pin
22 pin opening
23 boundary line
24 blade substrate
24A top surface
24B bottom surface
25 opening
30 case member
31 exit aperture
32 rotation pin
40 cam member
41 entrance aperture
42 fan-shaped gear
43 cam groove
R1 first section
R2 second section
R3 third section
R4 fourth section
R5 support section
V1 actuation axis
V2 rotation axis

What is claimed is:

1. A light quantity adjustment device comprising:
a plurality of blade substrates that are each provided rotatably with a rotation axis and an actuation axis;
a first member that has a first center aperture, defines positions of the rotation axes along a circumferential direction of the first center aperture, and engages with base-end sides of the plurality of blade substrates via the rotation axes; and
a second member that sandwiches the plurality of blade substrates between the first member, has a second center aperture communicating with the first center aperture, and engages with the plurality of blade substrates via the actuation axes, wherein
the plurality of blade substrates are rotatable as the second member is rotated, between a housing position and a stopping position, where an amount by which the first center aperture is shielded at the stopping position is larger than an amount by which the first center aperture is shielded at the housing position,
each of the plurality of blade substrates includes a first section and a second section that is on a tip-end side with respect to the first section,
a bottom surface of the second section of the blade substrate is positioned higher in a thickness direction than a top surface of the first section of the blade substrate, and
when viewed from the thickness direction, at least at the stopping position, the second section of each of the plurality of blade substrates partially overlaps with the first section of another adjacent one of the plurality of blade substrates.

2. The light quantity adjustment device according to claim 1, wherein the second section includes a third section and a fourth section that is on the tip-end side with respect to the third section,
a bottom surface of the fourth section of the blade substrate is at a position higher than a top surface of the third section of the blade substrate in the thickness direction, and
in the view in the thickness direction, at least at the stopping position, the fourth section of each of the plurality of blade substrates partially overlaps with the third section of another adjacent one of the plurality of blade substrates.

3. The light quantity adjustment device according to claim 1, wherein the first section of the blade substrate and the second section of the blade substrate have a uniform thickness.

4. The light quantity adjustment device according to claim 1, wherein a boundary line between the first section and the second section extends between a first end and a second end on the blade substrate, the first end being positioned on an inner edge of the blade substrate and facing the first center aperture, and the second end being positioned on an outer edge facing away from the first center aperture, and
the first end is positioned on the tip-end side with respect to the second end.

5. The light quantity adjustment device according to claim 1, wherein the plurality of blade substrates have a common shape.

6. The light quantity adjustment device according to claim 1, wherein the blade substrate is provided across a range at least partially overlapping with the second member in the thickness direction, between the housing position and the stopping position, and has a support section enabled to come into contact with the second member, and
the support section has a height higher than a height of the first section.

7. The light quantity adjustment device according to claim 6, wherein the member forming the support section and the blade substrate are separate members.

8. The light quantity adjustment device according to claim 1, wherein an actuation pin defining the actuation axis is integrally fixed to the blade substrate, and has an intermediate surface higher than a height of the first section.

9. The light quantity adjustment device according to claim 2, wherein the blade substrate is provided across a range at least partially overlapping with the second member in the thickness direction, between the housing position and the stopping position, and has a support section enabled to come into contact with the second member, and
the support section has a height higher than a height of the third section.

10. The light quantity adjustment device according to claim 9, wherein the member forming the support section and the blade substrate are separate members.

11. The light quantity adjustment device according to claim 2, wherein an actuation pin defining the actuation axis is integrally fixed to the blade substrate, and has an intermediate surface higher than a height of the third section.

12. The light quantity adjustment device according to claim 1, wherein the blade substrate is an aluminum member having a thickness of 0.4 mm or more.

13. The light quantity adjustment device according to claim 1, wherein one surface of the blade substrate exhibits a characteristic diffusely reflecting light.

14. The light quantity adjustment device according to claim 1, wherein an opening area of the first center aperture increases in the thickness direction from the second member toward the first member.

15. The light quantity adjustment device according to claim 1, wherein the second member has a fitting hole communicating with the second center aperture across a range corresponding to the second section of the blade substrate positioned at the housing position.

16. A projection image display device comprising the light quantity adjustment device according to claim 1 at or near a pupil position, on a light path of illumination light.

17. The projection image display device according to claim 16, wherein an incident surface of the blade substrate exhibits a characteristic diffusely reflecting light in the light path.
